(19) United States
(12) Patent Application Publication
(10) Pub. No.: US 2018/0192494 A1
(43) Pub. Date: Jul. 5, 2018

(54) A NON-ISOLATED SWITCHING MODE POWER SUPPLY FOR A HIGH-VOLTAGE LIGHT STRIP

(71) Applicant: GUANGDONG OML TECHNOLOGY CO., LTD., Guangdong (CN)

(72) Inventor: Peiliang Zhang, Guangdong (CN)

(73) Assignee: GUANGDONG OML TECHNOLOGY CO., LTD., Guangdong (CN)

(21) Appl. No.: 15/311,660

(22) PCT Filed: Sep. 9, 2016
(86) PCT No.: PCT/CN2016/099034

§ 371 Date: Nov. 16, 2016

(30) Foreign Application Priority Data
Aug. 31, 2016 (CN) 201610786542.5

(51) Int. Cl. H05B 33/08; H02M 3/156; H02M 1/08; H02M 1/32; H02M 1/44

(52) U.S. Cl. CPC H05B 33/0887; H05B 33/0818; H02M 3/156; H02M 7/06; H02M 1/32; H02M 1/44; H02M 1/08

(57) ABSTRACT

A non-isolated switching mode power supply for a high-voltage light strip is disclosed. The non-isolated switching mode power supply comprises a full-bridge rectifier circuit, a switch tube Q2, an electrolytic capacitor C2, an energy-storage inductor L1, a diode D4 and a PWM circuit. A PWM signal output end of the PWM circuit is connected with a control electrode of the switch tube Q2, the switch tube Q2 and the diode D4 are in series connection between the two output ends of the full-bridge rectifier circuit, a negative electrode of the switch tube D4 is connected with a positive output end +VCC of the full-bridge rectifier circuit, and the energy-storage inductor L1 is connected between a negative electrode of the electrolytic capacitor C2 and a positive electrode of the diode D4. The non-isolated switching mode power supply utilizes a brand-new circuit structure; the voltage of the energy-storage inductor L1 is kept on 130V by virtue of pulse width modulation of the PWM circuit, so that the electrolytic capacitor C2 can always output high voltage of 180V, and the cost of the power supply is low. Therefore, the high-voltage light strip manufacturing enterprises can be more competitive than the others.

### FIELD OF THE INVENTION

The present invention relates to switching mode power supplies, and in particular to a non-isolated switching mode power supply for a high-voltage light strip.

### BACKGROUND OF THE INVENTION

A high-voltage LED strip is relatively simple to be installed, which can be driven directly by a high-voltage driver, usually it can be configured directly by the factories, and it works normally as long as it's connected to a power supply of 220V. Because the high-voltage LED strip matches with a high-voltage power supply, generally one high-voltage power supply can drive an LED strip with a length of 30-50 m, and the cost of high voltage is relatively low. At present, an existing high-voltage light strip works with an isolated switching mode power supply, and the price of an isolated switching mode power supply is relatively high, which is a considerable portion of cost in using the light strip. Therefore, in order to further reduce the use cost of the light strip and enable the manufacturing enterprises to stand out from the market competition, it is the key to reduce the cost of the high-voltage power supply.

### SUMMARY OF THE INVENTION

To overcome the defects of the prior art, the present invention aims at providing a low-cost non-isolated switching mode power supply for a high-voltage light strip.

In order to achieve the object of the present invention as described above, the present invention provides a technical scheme as follows:

A non-isolated switching mode power supply for a high-voltage light strip comprises a full-bridge rectifier circuit, a switch tube Q2, an electrolytic capacitor C2, an energy-storage inductor L1, a diode D4 and a PWM circuit. A PWM signal output end of the PWM circuit is connected with a control electrode of the switch tube Q2, and the switch tube Q2 and the diode D4 are in series connection between the two output ends of the full-bridge rectifier circuit; additionally, a negative electrode of the diode D4 is connected with a positive output end +VCC of the full-bridge rectifier circuit, the energy-storage inductor L1 is connected between a negative electrode of the electrolytic capacitor C2 and a positive electrode of the diode D4, a positive electrode of the electrolytic capacitor C2 is connected with the positive output end +VCC of the full-bridge rectifier circuit, and the positive electrode and the negative electrode of the electrolytic capacitor C2 are as the positive output end and the negative output end of the whole non-isolated switching mode power supply.

The non-isolated switching mode power supply further comprises a reference circuit, a comparison and amplification circuit, and an output sampling circuit, all of which are sequentially connected. The output sampling circuit is connected with the positive output end +VCC of the full-bridge rectifier circuit in order to obtain output voltage, and the comparison and amplification circuit is used for comparing the output voltage with reference voltage, and PWM signal width of the PWM circuit is regulated according to a comparison result there between.

The non-isolated switching mode power supply further comprises a relay RELAY1 and an input protection circuit. Contacts of the relay RELAY1 are in series connection between the positive electrode of the electrolytic capacitor C2 and the positive output end of the non-isolated switching mode power supply, and the input protection circuit is connected with a coil of the relay RELAY1 to control switching on and switching off of the contacts of the relay RELAY1.

The non-isolated switching mode power supply further comprises a start-up circuit and a power supply circuit. The start-up circuit comprises a transformer, a primary winding of the transformer is the energy-storage inductor L1, a secondary winding of the transformer is as an input end of the start-up circuit, and the start-up circuit provides working voltage for the PWM circuit.

The input ends of the full-bridge rectifier circuit are connected with an EMC circuit.

Input ends of the EMC circuit are connected with a surge protection circuit, and input ends of the surge protection circuit are used for connecting AC 220V.

The present invention has beneficial effects as follows:

The non-isolated switching mode power supply utilizes a brand-new circuit structure, and is based on a connection relationship of the full-bridge rectifier circuit, the switch tube Q2, the electrolytic capacitor C2, the energy-storage inductor L1, the diode D4 and the PWM circuit. The voltage of the energy-storage inductor L1 is kept on 130V by virtue of pulse width modulation of the PWM circuit, so that the electrolytic capacitor C2 can always output high voltage of 180V, and the cost of the power supply is low. Therefore, the high-voltage light strip manufacturing enterprises can be more competitive than the others.

### BRIEF DESCRIPTION OF THE DRAWINGS

The embodiments provided in the present invention are further described with reference to the accompanying drawings.

FIG. 1 is a circuit schematic block diagram of a non-isolated switching mode power supply according to the present invention;

FIG. 2 is a circuit diagram of a front side surge, EMC and rectifier module, according to the present invention;

FIG. 3 is a circuit diagram of a start-up circuit and a power supply circuit;

FIG. 4 is a circuit diagram of a PWM circuit;

FIG. 5 is a circuit diagram of a reference circuit;

FIG. 6 is a circuit diagram of a comparison and amplification circuit and an output sampling circuit;

FIG. 7 is a circuit diagram of an input protection circuit and a relay.

### DETAILED DESCRIPTION OF THE EMBODIMENTS

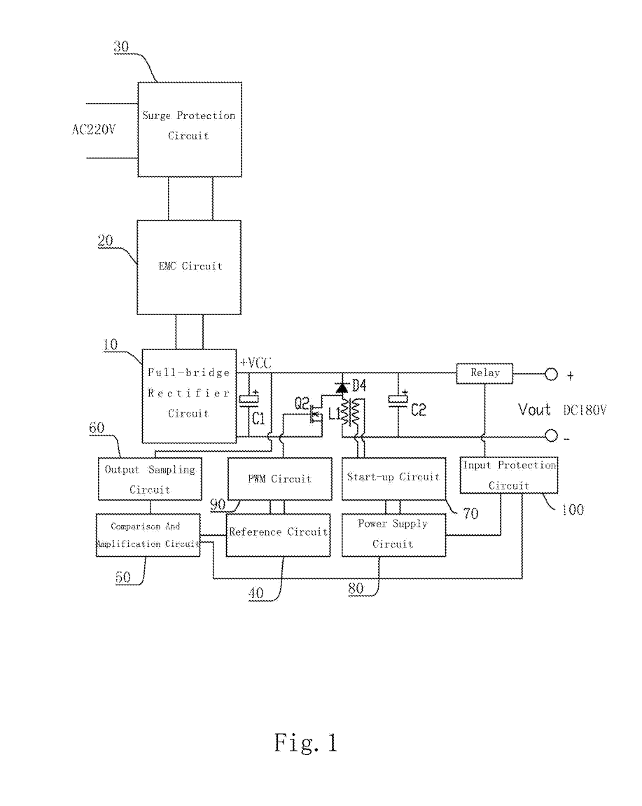

FIG. 1 is a non-isolated switching mode power supply for a high-voltage light strip, according to the present invention. The non-isolated switching mode power supply for the high-voltage LED strip comprises a full-bridge rectifier circuit 10, a switch tube Q2, an electrolytic capacitor C2, an energy-storage inductor L1, a diode D4, a PWM circuit 90 and a filtering capacitor C1 connected between the two output ends of the full-bridge rectifier circuit 10. In the embodiment, a field effect transistor is used as the switch tube Q2, however it's not limiting to the field effect transistor, other conventional and alternative switch tubes as known are also applicable in the present invention.

A connection relationship of the circuits above is as follows: a PWM signal output end of the PWM circuit 90 is connected with a control electrode of the switch tube Q2, the switch tube Q2 and the diode D4 are in series connection between the two output ends of the full-bridge rectifier circuit 10, a negative electrode of the diode D4 is connected with a positive output end +VCC of the full-bridge rectifier circuit 10, the energy-storage inductor L1 is connected between a negative electrode of the electrolytic capacitor C2 and a positive electrode of the diode D4, a positive electrode of the electrolytic capacitor C2 is connected with the positive output end +VCC of the full-bridge rectifier circuit 10, and the positive electrode and the negative electrode of the electrolytic capacitor C2 are as the positive output end and the negative output end of the whole non-isolated switching mode power supply.

Its working principle is as follows: after alternating current of an AC 220V is directly rectified and filtered, input voltage VCC is equal to 311V; when the switch tube Q2 is conducted, the diode D4 is blocked, the electrolytic capacitor C2 is charged, the current flows into the energy-storage inductor L1 through the electrolytic capacitor C2, and the energy-storage inductor L1 stores electric energy; when the switch tube Q2 is switched off, the diode D4 is conducted, the energy-storage inductor L1 releases the energy, the current charges a load and the electrolytic capacitor C2 through the diode D4, and switching on and switching off of the switch tube Q2 are controlled by virtue of pulse width modulation of the PWM circuit 90, and the voltage of the energy-storage inductor L1 is controlled to keep on 130V, so that the electrolytic capacitor C2 can always output the high voltage of 180V.

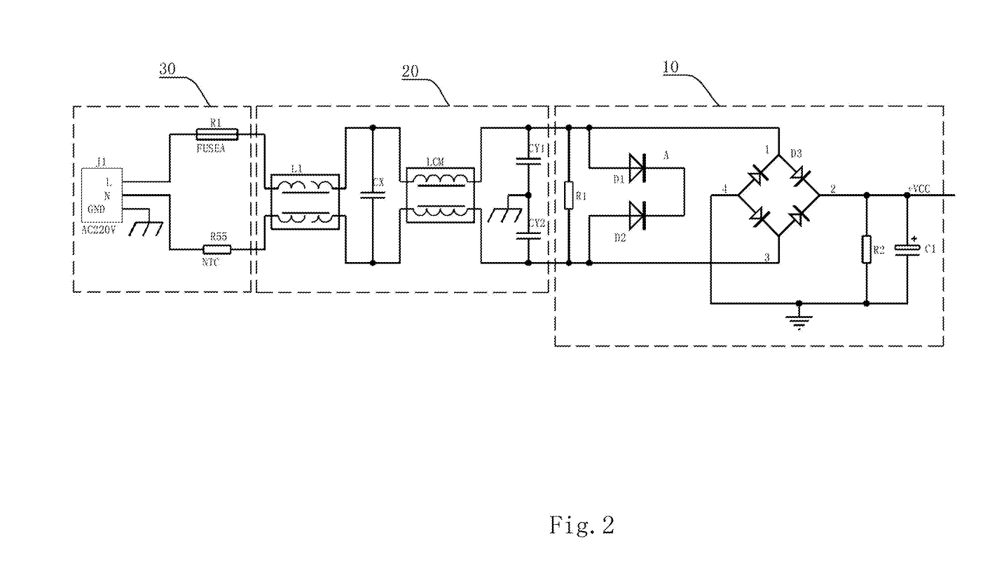

As shown in the FIG. 2, the input ends of the full-bridge rectifier circuit are connected with an EMC circuit 20 to perform electromagnetic interference resistance. Input ends of the EMC circuit 20 are connected with a surge protection circuit 30 so as to prevent surge impact of network voltage, and input ends of the surge protection circuit 30 are used for connecting AC 220V.

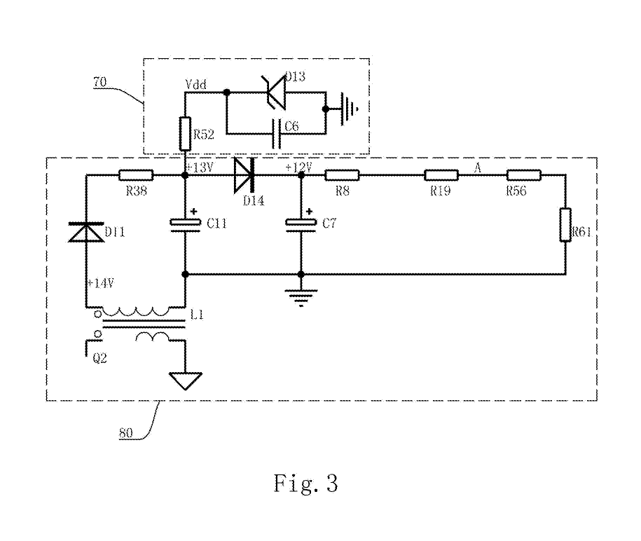

As shown in the FIG. 3, the non-isolated switching mode power supply further comprises a start-up circuit 70 and a power supply circuit 80. The start-up circuit 70 has a transformer, a primary winding of the transformer is the energy-storage inductor L1, a secondary winding of the transformer is as an input end of the start-up circuit 70, the start-up circuit 70 provides working voltage for the PWM circuit 90, and the power supply circuit 80 provides working voltage Vdd for other circuits according to the present invention.

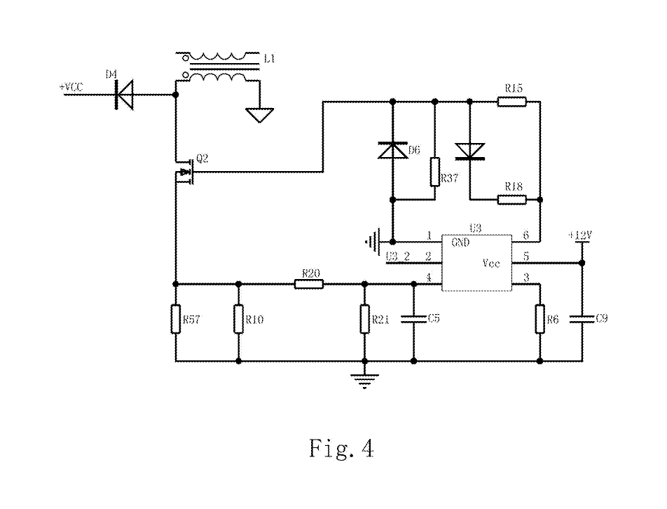

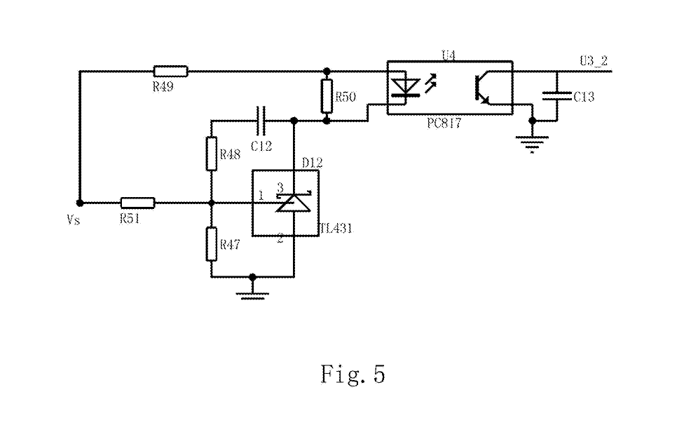

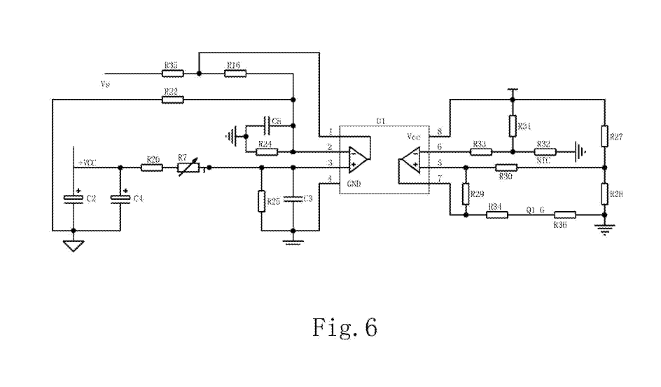

As shown in the FIG. 4-6, the non-isolated switching mode power supply further comprises a reference circuit 40, a comparison and amplification circuit 50, and an output sampling circuit 60, all of which are sequentially connected. The output sampling circuit 60 is connected with the positive output end +VCC of the full-bridge rectifier circuit 10 in order to obtain output voltage, and the comparison and amplification circuit 50 is used for comparing the output voltage with reference voltage, and PWM signal width of the PWM circuit 90 is regulated according to a result of the comparison there between, wherein the result of the comparison is fed back to an IC chip U1 of the PWM circuit 90 through an optical coupler U4 of the reference circuit 40 so as to achieve constancy of the output voltage.

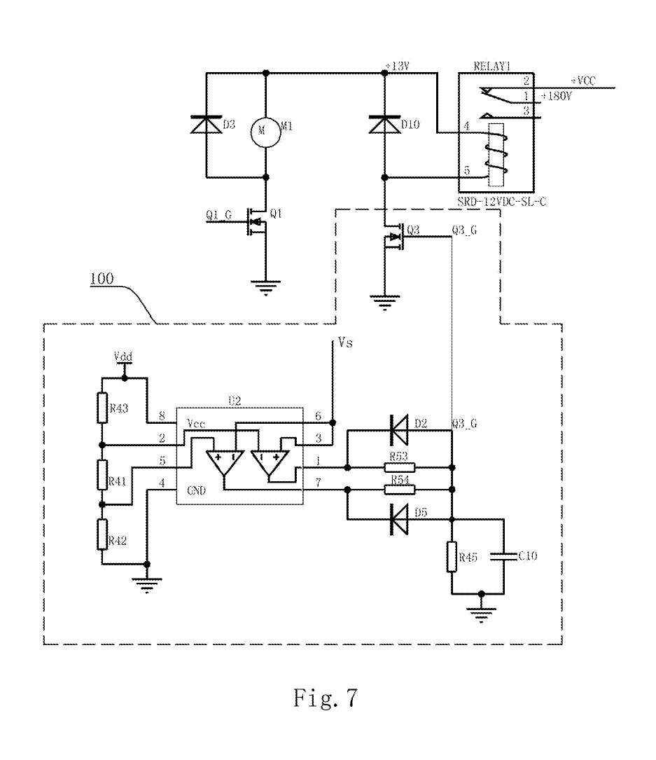

As shown in the FIG. 7, the non-isolated switching mode power supply further comprises a relay RELAY1 and an input protection circuit 100. Contacts of the relay RELAY1 are in series connection between the positive electrode of the electrolytic capacitor C2 and the positive output end of the non-isolated switching mode power supply, and the input protection circuit 100 is connected with a coil of the relay RELAY1 to control switching on and switching off of the contacts of the relay RELAY1. The input protection circuit 100 is used for detecting sampling voltage Vs to control switching on and switching off of the relay. When the input voltage is normal (AC190V-AC264V), the sampling voltage Vs is from 3V to 6V, thus an IC output pin 7 is at low-level, and the relay outputs normally; when the input voltage AC 220V exceeds 265V, the sampling voltage is greater than 6V, thus the IC output pin 7 is at high-level, and the relay switches off the output; and when the input voltage AC 220V is smaller than 190V, the sampling voltage is smaller than 3V, thus the IC output pin 7 is at high-level, and the relay switches off the output; therefore, open circuit protection is achieved when the input voltage is overvoltage or undervoltage.

Furthermore, the non-isolated switching mode power supply is also provided with a fan M1 for heat dissipation. The fan M1 is controlled by the field effect transistor Q1. A control electrode G of the field effect transistor Q1 is connected with the comparison and amplification circuit 50, and controls the on and off of the fan according to the specific output voltage.

The foregoing descriptions are merely preferable embodiments of the present invention, but not intended to limit the present invention. Technical schemes achieving the purposes of the present invention with substantially the same means shall fall within the protection scope of the present invention.

1. A non-isolated switching mode power supply for a high-voltage light strip comprising:
a full bridge rectifier circuit,
a switch tube Q2,
an electrolytic capacitor C2, wherein a positive electrode of the electrolytic capacitor C2 is connected with the positive output end +VCC of the full-bridge rectifier circuit, the positive electrode and the negative electrode of the electrolytic capacitor C2 are as a positive output end and a negative output end of the non-isolated switching mode power supply,
an energy-storage inductor L1 connected between a negative electrode of the electrolytic capacitor C2 and a positive electrode of a diode D4,
a diode D4, wherein the switch tube Q2 and the diode D4 are in series connection between the two output ends of the full-bridge rectifier circuit, a negative electrode of the diode D4 is connected with a positive output end +VCC of the fully bridge rectifier circuit, and
a PWM circuit, wherein a PWM signal output end of the PWM circuit is connected with a control electrode of the switch tube Q2.

2. The non-isolated switching mode power supply according to claim 1 further comprising:
a reference circuit,
an output sampling circuit connected with the positive output end +VCC of the full-bridge rectifier circuit in order to obtain an output voltage, and
a comparison and amplification circuit used for comparing the output voltage with reference voltage, and PWM signal width of the PWM circuit is regulated according to a comparison result there between,
wherein all of the reference circuit, the comparison and amplification circuit and the output sampling circuit are sequentially connected.

3. The non-isolated switching mode power supply according to claim 1 further comprising:
a relay RELAY1, wherein contacts of the relay RELAY1 are in series connection between the positive electrode of the electrolytic capacitor C2 and the positive output end of the non-isolated switching mode power supply, and
an input protection circuit connected with a coil of the relay RELAY1 to control switching on and switching off of the contacts of the relay RELAY1.

4. The non-isolated switching mode power supply according to claim 1 further comprising:
a start-up circuit comprising a transformer and providing working voltage for the PWM circuit, wherein the transformer comprises:
a primary winding as the energy-storage inductor L1;
a secondary winding as input ends of the start-up circuit; and
a power supply circuit.

5. The non-isolated switching mode power supply according to claim 1, wherein the input ends of the full-bridge rectifier circuit are connected with an EMC circuit.

6. The non-isolated switching mode power supply according to claim 5, wherein input ends of the EMC circuit is connected with a surge protection circuit, and an input end of the surge protection circuit are used for connecting AC 220V.

7. The non-isolated switching mode power supply according to claim 2 further comprising:
a start-up circuit comprising a transformer and providing working voltage for the PWM circuit, wherein the transformer comprising:
a primary winding as the energy-storage inductor L1;
a secondary winding as input ends of the start-up circuit; and
a power supply circuit.

8. The non-isolated switching mode power supply according to claim 3 further comprising:
a start-up circuit comprising a transformer and providing working voltage for the PWM circuit, wherein the transformer comprising:
a primary winding as the energy-storage inductor L1;
a secondary winding as input ends of the start-up circuit; and
a power supply circuit.
